(19) United States
(12) Patent Application Publication
(10) Pub. No.: US 2015/0220581 A1
(43) Pub. Date: Aug. 6, 2015

(54) Method of Data Entry

(71) Applicant: STS SOFT AD, Gabrovo (BG)

(72) Inventors: Iliya Tronkov, Sofia (BG); Atanas Todorov, Yambol (BG); Svetoslav Mateev, Gabrovo (BG); Stefan Ganchev, Gabrovo (BG)

(21) Appl. No.: 14/421,384

(22) PCT Filed: May 10, 2013
(86) PCT No.: PCT/BG2013/000019

§ 371 Date: Feb. 12, 2015

(30) Foreign Application Priority Data
Aug. 14, 2012 (BG) 111291

(51) Int. Cl. G06F 17/30

(52) U.S. Cl. CPC G06F 17/30327

(57) ABSTRACT

This invention relates to a method of data indexing on external storage devices by a specific index tree and it is applied in data bases, file systems, etc. It is based on B⁺-tree which is characterized by the fact that adjacent operations are recorded in addition to each branch of the internal nodes of the tree. After accumulating, these operations pour down in groups to lower nodes. The number of physical operations is minimized by the method when employing external storage devices and their life cycle is pro longed. The speed of indexing is enhanced many times without being substantially affected by the order of inputting the operations.

### TECHNICAL FIELD

This invention is concerned with a method of data indexing on external storage devices by a specific index tree and it is applied to data bases, file systems, etc.

### BACKGROUND ART

A method of data indexing through B⁺-tree [1][2][3] is known, which comprises:

1. An operation is input to the index tree. The operation contains obligatory fields—type, key and optional fields (data, order of operations, attributes, etc.) and it has the following logical structure:
each node of the tree is either a leaf or internal node;
each leaf contains a sequence of records, and the record is an ordered pair (key, value);
each internal node contains a sequence of branches and the branch is an ordered pair (key, pointer to node);
dependencies between keys and nodes are defined in [1].

2. The operation is executed immediately in the following way:

2.1 The root node of the index tree is assigned to variable N of node type;

2.2 The new-coming operation is applied to node N, according to its type:

2.2.1 If N is an internal node—according to the operation key, branch b is found in N in one of the known ways and after that the node pointed by b is assigned to variable N. Go to 2.2, as the operation becomes new-coming for N;

2.2.2 If N is a leaf—the new-coming operation is applied to records in N, whereat records with unique keys always remain in the leaf, and depending on the number of records in N, one of the following actions is executed:
N overflows with records, i.e. the number of records in N is greater than the preset limit—the leaf splits or overflows in one of the known ways and if necessary the splitting process spreads up the tree;
N underflows, i.e. the number of records in N is smaller than the preset limit—the leaf merges with an adjacent leaf in one of the known ways and if necessary the merging process spreads up the tree;
N neither overflows nor underflows—the performance of the input operation method ends.

A disadvantage of the known B⁺-tree method is that the required speed of indexing cannot be reached through it when inputting operations whose keys form a non-monotonous sequence. This is due to too frequent application of the slow operation of random access to external storage devices separately for each of the input operations. To compensate for this disadvantage, it is necessary almost all data to be loaded in the main memory.

### SUMMARY OF INVENTION

The object of this invention is to develop a method of indexing data on external storage devices by which to minimize the number of physical operations on these devices and prolong their service life.

An additional object of the invention is the method to be applicable in an environment of limited computing resources.

The set problems have been solved by the proposed method which comprises the following:

1. One or more operations are input to the index tree which has a logical structure similar to B⁺-tree, but in addition each branch of an internal node has adjacent operations as well;

2. The operations have a deferred execution in the following manner:

2.1 The root node of the index tree is assigned to variable N of node type;

2.2 The new-coming operations are applied to node N, according to its type:

2.2.1 If N is an internal node—it is executed in succession:

2.2.1.1 For each newly-come operation o branch b is found in N, according to the key of the operation in one of the known ways, and then o is applied to operations adjacent to b. Two possible cases exist:
if there are operations adjacent to b with keys identical to the key of o, o is applied to these operations according to predefined rules and as a result, the number of these adjacent operations can be changed and/or the fields of some of them can be modified;
if there are no operations adjacent to b with keys identical to the key of o, then o is added to them.

2.2.1.2 Check if node N overflows with operations, i.e. if their total number exceeds a preset limit. Two possible cases exist:
node N overflows—part of the operations of N pour down the tree until their total number is reduced below a preset limit. To this end, each time branch b of N is selected for which the greatest number of adjacent operations have been accumulated and they sink down the tree following branch b, i.e. all operations adjacent to b are removed. Then go to 2.2 with the node pointed by b and the removed operations;
node N does not overflow—the performance of the input operations method ends.

2.2.2 If N is a leaf—each newly come operation is applied to the records in N according to predefined rules, whereat records with unique keys always remain in the leaf and depending on the number of records in N, one of the following actions is executed:
N overflows with records, i.e. the number of records in N is greater than a preset limit—the leaf splits in one of the known manners and if necessary the process of splitting spreads up the tree, similarly to B⁺-tree, with the difference that the branches carry their adjacent operations with them and in case the newly formed leaves overflow with records, the splitting process is executed for them as well;
N underflows, i.e. the number of records in N is smaller than a preset limit—the leaf merges with an adjacent leaf and if necessary the merging process spreads up the tree, similarly to B⁺-tree, with the difference that branches carry their adjacent operations with them as well. In case the newly obtained leaves underflow with records, the merging process is executed for them as well;
N neither overflows nor underflows—the performance of the input operations method ends.

This invention has the following advantages:
it minimizes the number of physical operations when employing external storage devices and it lengthens their life cycle;
the speed of indexing on external storage devices is enhanced when input operations whose keys form a non-monotonous sequence;
the indexing speed is not affected substantially by the order of operations input;
an opportunity is provided for uniting a set of indices at logical level in one index tree without deteriorating the speed of indexing;
natural execution of mass operations;
it is applicable to devices with limited computing resources and especially with smaller main memory as mobile devices, microcontrollers, tablets, laptops, notebooks, etc.;
it is suitable for building file systems and for embedding into data base management systems;
integration at firmware level is also possible—in hard disks, flash memories, RAID systems, data servers, etc.

### BRIEF DESCRIPTION OF DRAWINGS

FIG. 1 is a simplified block diagram of the method of indexing.

FIG. 2 shows a schematic logical structure of an index tree.

FIG. 3 illustrates the stages of building an index tree according to this invention.

FIG. 4 shows a schematic logical structure of an index tree with records in the branches as well.

### DESCRIPTION OF EMBODIMENTS

Preferred embodiments of the method have been developed and described below without limiting the method only to the presented embodiments.

### Embodiment 1

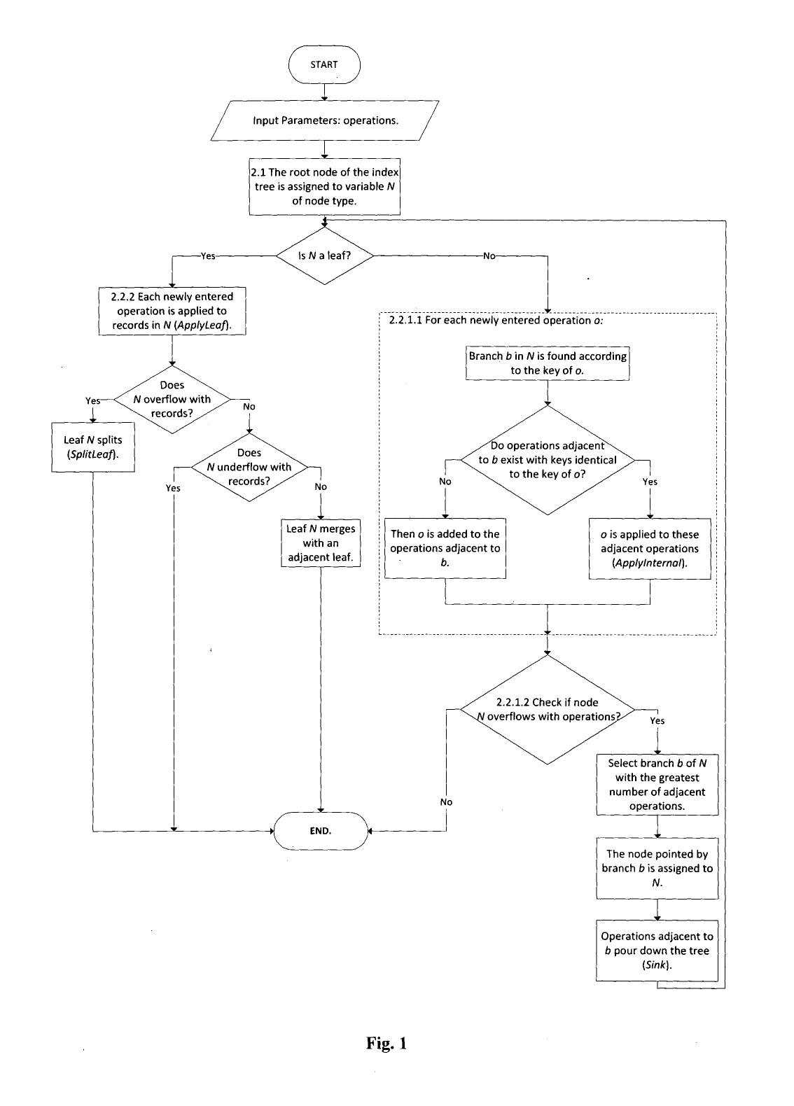

A method of indexing data with four types of operations Replace, InsertOrIgnore, Read, Delete (FIG. 1), comprises the following:

1. Operations o₁, o₂, . . . , oₙ are input to the index tree which has the following logical structure:

1.1 The logical structure of W-tree is a directed tree which has two types of nodes—leaves and internal nodes, and each node of the tree is a physical page of the external storage device, and the physical address of the page is a pointer to the node;

1.2 A node is a leaf if it does not contain any branches to other nodes. Each leaf of the tree contains a sequence of records r₁, r₂, . . . , rₗ.

Each record r is an ordered pair (key, value)—r(k, v). The “key” field of the record is of arbitrary type for which an ordinance has been defined. The “value” field of the record contains user data which are not subjected to transformation.

Throughout the description below where it is necessary to access a particular field of a certain variable, contextual (dot) notation will be used. For example, r.k means the key of record r, and r.v means the value of record r. The records in the index tree have unique keys and they are ordered according to them, therefore the following conditions are met for the records in the sequence of each leaf:
if i≠j, then rⱼ.k≠rⱼ.k is fulfilled for the keys of the records;
if i<j, then rᵢ.k<rⱼ.k is fulfilled for the keys of the records,

where i and j are arbitrary indices of the sequence.

The number of records l in each leaf is between R≦l≦R, where R and R are respectively minimum and maximum number of records in a leaf. When the leaf node is a root node, then R=0, in all other cases

$$\underline{R} = \frac{\overline{R}}{2} ,$$

i.e. the value of R depends on whether the leaf node is a root node of the tree. The path from each leaf to the root node contains an equal number of nodes, i.e. the tree is balanced;

1.3 A node is internal if it is not a leaf. Each internal node of the tree contains a sequence of branches and operations

$$( {b}_{0} , {o}_{{0}_{1}} , {o}_{{0}_{2}} , … , {o}_{{0}_{{1}_{0}}} ) , ( {b}_{1} , {o}_{{1}_{1}} , {o}_{{1}_{2}} , … , {o}_{{1}_{{1}_{1}}} ) , … , ( {b}_{n} , {o}_{{n}_{1}} , {o}_{{n}_{2}} , … , {o}_{{n}_{{1}_{n}}} ) .$$

Each branch b is an ordered pair (key, pointer to node)—b(k, p). The following conditions have been met for the branches in the sequence of each internal node:
they have unique keys, i.e. if i≠j, then bᵢ.k≠b₁.k is met for the branch keys;
they are ordered by their keys, i.e. if i<j, then for the branch keys is met bᵢ.k<bᵢ.k,

where i and j are random indices of the sequence.

The number of branches n+1 in each internal node is between B≦n+1≦ B̅, where B and B̅ are respectively the minimum and maximum number of branches in an internal node. When the internal node is the root, then B=2, in all other cases

$$\underline{B} = \frac{\overline{B}}{2} ,$$

i.e. the value of B depends on whether the node is the root.

Each operation o is an ordered quadruple (key, value, type, identifier)—o(k, v, t, a). The “type” field takes one of the following values {Replace, Delete, InsertOrIgnore, Read}. The “identifier” field is the sequential number of the operation within the existence of the index tree. Operations oᵢ_{ₛ}, for each s=1, 2, . . . , lⱼ are called adjacent operations of branch bᵢ. The adjacent operations oᵢ_{ₛ} of branch bᵢ are ordered first by key and then by identifier, i.e. oᵢ_{ₘ}<oᵢ_{ₙ}:
if oᵢ_{ₘ}.k<oᵢ_{ₙ}.k;
or
if oᵢ_{ₘ}.k=oᵢ_{ₙ}.k and oᵢ_{ₘ}.a<oᵢ_{ₙ}.a,

where m and n are random indices of branches in an internal node and m<n.

Simultaneously, for each internal node the keys of the adjacent operations of branch bᵢ are equal or greater than its key bᵢ.k and smaller than key bᵢ₊₁.k of the next branch bᵢ₊₁ in the node if it exists, i.e.:
bᵢ.k≦oᵢ_{ₛ}.k;
oᵢ_{ₛ}.k<bᵢ₊₁.k,

for any s=1, 2, . . . , lⱼ.

The number of operations l₀+l₁+ . . . +lₙ in each internal node is between O≦l₀+l₁+ . . . +lₙ≦Ō, where O=0 and Ō are respectively the minimum and maximum number of operations in an internal node.

The internal nodes of the tree serve also for navigation to leaves, i.e. to records;

1.4 If bᵢ is any branch in a certain internal node N, and K(bᵢ) is the set of all keys in the maximum subtree, for which bᵢ is a root, irrespectively if the keys belong to records, operations or branches, then the following relations between bᵢ.k and each xεK(bᵢ) are met:
a) bᵢ.k≦x;
b) if in N next branch bᵢ₊₁ exists, then x<bᵢ₊₁.k;

1.5 The empty tree consists of one node which is of leaf type;

1.6 Root node [symbol] is the one for which there is no branch in the tree pointing to it. [symbol] can be either a leaf or an internal node;

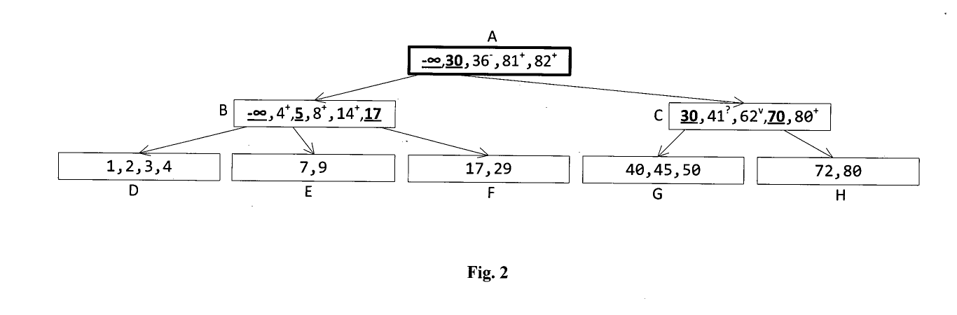

The logical structure described above is presented in FIG. 2, with a maximum number of branches in the internal nodes—3, maximum number of records in the leaves—4 and maximum number of operations in the internal nodes—9, where nodes A, B and C are internal, and nodes D, E, F, G and H are leaves. Node A is the root of the tree. Without limiting the generality, in the example of key type, the set of natural numbers [symbol] ={1, 2, . . . } is chosen, and the following symbols are introduced:
upper indices indicate the type of operation:
   ⁺—operation of Replace type;
   ⁻—operation of Delete type;
   ^{v}—operation of InsertOrIgnore type;
   ^{?}—operation of Read type,
numbers with no index are records;
numbers in bold and underlined are branches.

2. Input operations o₁, o₂, . . . , oₙ are executed in the following deferred manner:

2.1 The root node [symbol] of the index tree is assigned to variable N of node type;

2.2 Operations o₁, o₂, . . . , oₙ are applied to node N, according to its type, executing procedure Apply(N, o₁, o₂, . . . , oₙ):

2.2.1 if N is an Internal Node:

2.2.1.1 The procedure ApplyInternal(N, o₁, o₂, . . . , oₙ) is performed, i.e. the sequence of operations o₁, o₂, . . . , oₙ is applied to the internal node N;

2.2.1.2 Check if the number of operations in N is greater than Ō. There are two cases:
if ‘yes’—branch bₖ of N is chosen, which has the greatest number of adjacent operations and after that procedure Sink(N, bₖ) is executed, i.e. the adjacent operations of bₖ pour down the tree. The process of choosing a branch with the greatest number of adjacent operations in N and their pouring down is repeated until the number of operations in N is reduced below a preset limit;
if ‘no’—end of Apply( ).

2.2.2 if N is a Leaf:

2.2.2.1 Procedure ApplyLeaf(N, o₁, o₂, . . . , oₙ) is executed, i.e. the sequence of operations o₁, o₂, . . . , oₙ is applied to leaf N;

2.2.2.2 The number of records in N is checked if it is greater than R̅ and in case it is greater, procedure SplitLeaf(N) is executed, i. e. a sequence of actions for splitting leaf N and after it is finished, Apply( ) is ended;

2.2.2.3 The number of records in N is checked if it is smaller than R and in case it is smaller, procedure MergeLeaf(N) is executed, i.e. a sequence of actions for merging leaf N with an adjacent one and after it is finished, Apply( ) is ended.

Procedure Sink(N, bₖ), for Pouring the Adjacent Operations of Branch bₖ from Internal Node N Down the Tree, Comprising:

The adjacent operations

$${O}_{{k}_{1}} , {o}_{{k}_{2}} , … , {o}_{{k}_{{1}_{k}}}$$

of bₖ are removed from N, after that the procedure Apply

$$( {b}_{k} \cdot p , {o}_{{k}_{1}} , {o}_{{k}_{2}} , … , {o}_{{k}_{{1}_{k}}} )$$

is executed, i.e. the sequence of operations

$${o}_{{k}_{1}} , {o}_{{k}_{2}} , … , {o}_{{k}_{{1}_{k}}}$$

is applied to the node pointed by bₖ.p, as the reference to bₖ.p causes a physical operation on the internal storage device.

Procedure ApplyLeaf(N, o₁, o₂, . . . , oₙ), for Applying a Sequence of Operations o₁, o₂, . . . , oₙ on Leaf N, Comprises:

Consecutively, for each operation o from o₁, o₂, . . . , oₙ it is checked if there is record r in N, for which r.k=o.k is fulfilled. The following cases exist:
1. r exists and o.t=Replace—it is assigned to r.v←o.v;
2. r exists and o.t=Delete—record r is removed from N;
3. r exists and o.t=InsertOrIgnore—do nothing;
4. r exists and o.t=Read—record r returns as result;
5. r does not exist and o.t=Replace—record (o.k, o.v) is added to N;
6. r does not exist and o.t=Delete—do nothing;
7. r does not exist and o.t=InsertOrIgnore—record (o.k, o.v) is added to N;
8. r does not exist and o.t=Read—result null returns;

The eight cases above can also be presented in matrix form, as follows:

| | | record r does not exist, |
|---|---|---|
| o.t | record r exists, so that r.k = o.k | so that r.k = o.k |
| Replace | it is assigned to r.v ← o.v. | record (o.k, o.v) is |
| | | added to N. |
| Delete | record r is removed from N. | do nothing. |
| InsertOrIgnore | do nothing. | record (o.k, o.v) is |
| | | added to N. |
| Read | record r returns as result. | result null returns. |

Procedure ApplyInternal(N, o₁, o₂, . . . oₙ), for Applying a Sequence of Operations o₁, o₂, . . . , oₙ to Internal Node N, Comprises:

Consecutively, for each operation o from o₁, o₂, . . . , oₙ procedures 1 and 2 are executed.
1. Branch bᵢ of N is chosen, for which the following conditions are fulfilled simultaneously:
   a) bᵢ.k≦o.k;
   b) if next branch bᵢ₊₁ exists in N, then o.k<bᵢ₊₁.k;
2. Sequence S=oᵢ_{ₛ}, oᵢ_{ₛ₊₁}, . . . , oᵢ_{ᵤ} of adjacent operations of b₁ is chosen, for which oᵢ_{ᵥ}.k=o.k is fulfilled, where v=s, s+1, . . . , u, and depending on the number c of operations in S, the following two cases exist:
   2.1. c=0—add o to adjacent operations of bᵢ;
   2.2. c>0—depending on the type of oᵢ_{ᵤ}.t, of the last operation of sequence S, the following examples occur:
      2.2.1. oᵢ_{ᵤ}.t=Replace and o.t=Replace—replace oᵢ_{ᵤ} with o;
      2.2.2. oᵢ_{ᵤ}.t=Replace and o.t=Delete—replace oᵢ_{ᵤ} with o;
      2.2.3. oᵢ_{ᵤ}.t=Replace and o.t=InsertOrIgnore—do nothing;
      2.2.4. oᵢ_{ᵤ}.t=Replace and o.t=Read—record (oᵢ_{ᵤ}.k, oᵢ_{ᵤ}.v) returns as result;
      2.2.5. oᵢ_{ᵤ}.t=Delete and o.t=Replace—replace oᵢ_{ᵤ} with o;
      2.2.6. oᵢ_{ᵤ}.t=Delete and o.t=Delete—do nothing;
      2.2.7. oᵢ_{ᵤ}.t=Delete and o.t=InsertOrIgnore—replace oᵢ_{ᵤ} with operation (o.k, o.v, Replace, o.a);
      2.2.8. oᵢ_{ᵤ}.t=Delete and o.t=Read—result null returns;
      2.2.9. oᵢ_{ᵤ}.t=InsertOrIgnore and o.t=Replace—replace oᵢ_{ᵤ} with o;
      2.2.10. oᵢ_{ᵤ}.t=InsertOrIgnore and o.t=Delete—replace oᵢ_{ᵤ} with o;
      2.2.11. oᵢ_{ᵤ}.t=InsertOrIgnore and o.t=InsertOrIgnore; do nothing;
      2.2.12. oᵢ_{ᵤ}.t=InsertOrIgnore and o.t=Read—add o to N;
      2.2.13. oᵢ_{ᵤ}.t=Read and o.t=Replace—add o to N;
      2.2.14. oᵢ_{ᵤ}.t=Read and o.t=Delete—add o to N;
      2.2.15. oᵢ_{ᵤ}.t=Read and o.t=InsertOrIgnore—add o to N;
      2.2.16. oᵢ_{ᵤ}.t=Read and o.t=Read—add o to N;

The sixteen cases above can also be presented in matrix form, as follows:

| | oᵢ_{ᵤ}.t | | | |
|---|---|---|---|---|
| | | | InsertOr | |
| o.t | Replace | Delete | Ignore | Read |
| Replace | replace oᵢ_{ᵤ} with o. | replace oᵢ_{ᵤ} with o. | replace oᵢ_{ᵤ} with o. | add o to N. |
| Delete | replace oᵢ_{ᵤ} with o. | do nothing. | replace oᵢ_{ᵤ} with o. | add o to N. |
| InsertOr | do nothing. | replace oᵢ_{ᵤ} by operation | do nothing. | add o to N. |
| Ignore | | (o.k, o.v, Replace, o.a). | | |
| Read | record (oᵢ_{ᵤ}.k, oᵢ_{ᵤ}.v) | result null returns. | add o to N. | add o to N. |
| | returns as result. | | | |

Procedure SplitLeaf(L), for Splitting Leaf L, Comprising:

Record r1/2 (medium by index) is selected from the sequence of records r₁, r₂, . . . , rₗ of L.

A new leaf L′ is created and records r1/2, r1/2+1, . . . , rₗ are transferred to it from L, and records r₁, r₂, . . . , r1/2−1 remain in L. There are two cases if L is the root of the tree:
L is a root—a new internal node P is created and two new branches b₀(−∞, L) and b₁(r1/2.k,L′) are added to it, pointing respectively to L and L′, with keys respectively b₀.k=−∞ and b₁.k=r1/2.k, where −∞ is a virtual key which is smaller than all possible keys. P is the new root of the index tree and it is parent node of L and L′, i.e. the height of the index tree is increased by one level;
L is not a root—a new branch b(r1/2.k,L′) is added to parent node P of L, with key b.k=r1/2.k and pointing to leaf L′. So P becomes parent node to L′ as well. In case, after adding b to P the number of branches in P is larger than B̅, i.e. P has overflowed with branches, procedure Splitlnternal(P) is executed, i.e. a sequence of actions for splitting internal node P.

Procedure SplitInternal(I), for Splitting Internal Node I, Comprising:

Procedure for splitting internal node I is similar to the procedure for splitting a leaf but the difference is that it is performed in terms of the branches in the internal node.

Select branch (with middle index)

$$\frac{{b}_{n + 1}}{2}$$

from sequence of branches b₀, b₂, . . . , bₙ of I.

A new internal node I′ is created and branches

$$\frac{{b}_{n + 1}}{2} , \frac{{b}_{n + 1}}{2} + 1 , … , {b}_{n}$$

are transferred from I, with their adjacent operations, and branches

$${b}_{0} , {b}_{1} , … , \frac{{b}_{n + 1}}{2} - 1 ,$$

remain in I together with their adjacent operations. There are two cases depending whether I is the root of the tree:
l is a root—a new internal node P is created and two new branches b₀(−∞, I) and

$${b}_{1} ( {b}_{\frac{n + 1}{2}} \cdot k , {I}^{′} )$$

are added to it, with keys respectively b₀.k=−∞ and

$${b}_{1} \cdot k = \frac{{b}_{n + 1}}{2} \cdot k ,$$

pointing respectively to I and I′. P is the new root of the index tree and it becomes parent node to I and I′, i.e. the height of the tree increases by one level;
l is not a root—in parent node P of I a new branch

$$b ( {b}_{\frac{n + 1}{2}} \cdot k , {I}^{′} )$$

is added, with key

$$b \cdot k = {b}_{\frac{n + 1}{2}} \cdot k ,$$

pointing to leaf I′. Thus P is parent node of I′ as well. In case, after adding b to P the number of branches in P is greater than B̅, recursively procedure SplitInternal(P) is executed, i.e. a sequence of actions for splitting internal node P. The recursion can continue up to the root node including.

Procedure MergeLeaf(L), for Merging Leaf L with an Adjacent Leaf, Comprising:
1. From branches b₀, b₂, . . . , bₙ in parent node P of L branch bᵢ is selected, which points to L, i.e. bᵢ.p=L.
2. Procedure Sink(P, bᵢ) is executed, i.e. operations adjacent to bᵢ pour down the tree to L.
3. Depending to index i of branch bᵢ one of the following actions is performed:
   i=0—go to 3.1;
   i=n—go to 3.2;
   0<i<n—if the number of records in leaf bᵢ₊₁.p is smaller than the number of records in leaf bᵢ₋₁.p go to 3.1, otherwise, go to 3.2;
   3.1 Merging with a right leaf:
      Procedure Sink(P, bᵢ₊ᵢ) is executed, i.e. operations adjacent to bᵢ₊₁ pour down the tree.
      The records of the leaf pointed by bᵢ₊₁.p are added to L. They have no common keys with the old records in L.
      Branch bᵢ₊₁ is removed from P.
      Go to 4.
   3.2 Merging with a left leaf:
      Procedure Sink(P, bᵢ₋₁) is executed, i.e. operations adjacent to bᵢ₋₁ pour down the tree.
      The records of the leaf pointed by bᵢ₋₁.p are added to L. They have no common keys with the old records in L.
      Branch bᵢ₋₁ is removed from P.
      Go to 4.
4. Check if the number of records in L is greater than R̅:
   it is greater—procedure SplitLeaf(L) is executed for splitting leaf L, which will not lead to splitting P. End of MergeLeaf( )
   it is not greater—check if P is a root node:
      P is a root node—if bᵢ is the only branch of P, node P is erased and L is chosen to be the new root of the tree. The height of the tree decreases by one level. End of MergeLeaf( );
      P is not a root node—if the number of branches in P is smaller than B procedure MergeInternal(P) is executed for merging P with an adjacent internal node. End of MergeLeaf( ).

Procedure MergeInternal(I), for Merging Internal Node I with an Adjacent Internal Node, Comprising:

The procedure of merging internal nodes is similar to the procedure of merging leaves. The difference is that it is performed in terms of the branches of the internal node. When a branch moves from one node to another, its adjacent operations move with it.
1. From branches b₀, b₂, . . . , bₙ in parent node P of I branch bᵢ is selected, which points to I, i.e. bᵢ.p=I.
2. Procedure Sink(P, bᵢ) is executed, i.e. operations adjacent to bᵢ pour down the tree to I.
3. Depending on index i of branch bᵢ one of the following actions is performed:
   i=0—go to 3.1;
   i=n—go to 3.2;
   0<i<n—if the number of branches in internal node bᵢ₊₁.p is smaller than the number of branches in internal node bᵢ₋₁.p, go to 3.1, else go to 3.2;
   3.1 Merging with a right internal node:
      Procedure Sink(P, bᵢ₊₁) is executed, i.e. operations adjacent to bᵢ₊₁ pour down the tree.
      The branches of the internal node pointed by bᵢ₊₁.p are added to I. They have no common keys with the old branches in I.
      Branch bᵢ₊₁ is removed from P.
      Go to 4.
   3.2 Merging with a left internal node:
      Procedure Sink(P, bᵢ₋₁) is executed, i.e. operation adjacent to bᵢ₋₁ pour down the tree.
      The branches of the internal node pointed by bᵢ₋₁.p are added to I. They have not any common keys with the old branches in I.
      Branch bᵢ₋₁ is removed from P.
      Go to 4.
4. Check if the number of operations in I is greater than Ō and if it is greater, branch bₖ of I is selected which has the greatest number of adjacent operations and then procedure Sink(I, bₖ) is executed, i.e. operations adjacent to bₖ pour down the tree. The process of selecting a branch with the greatest number of adjacent operations in I and their pouring down is repeated until the number of operations in I is reduced below a preset limit;
5. Check if the number of branches in I is greater than B̅:
   it is greater—procedure. SplitInternal(I) is executed for splitting internal node I, which will not lead to splitting P. End of MergeInternal( )
   it is not greater—check if P is a root node:
      P is a root node—if b₁ is the only branch of P, erase node P and I is selected to be the new root of the tree. The height of the tree decreases by one level. End of MergeInternal( );
      P is not a root node—if the number of branches in P is smaller than B procedure MergeInternal(P) is executed for merging P with an adjacent internal node. End of MergeInternal( ).

Procedure for Searching Record r with key x in the Index Tree, Comprising:
1. r←null is assigned. The search starts from root node [symbol] . Root node [symbol] is assigned to variable N of node type, i.e. N← [symbol] .
2. Depending on the type of N there are two cases:
   2.1. N is a leaf—check if in the sequence of records in N record rᵢ exists, for which rᵢ.k=x is fulfilled:
      2.1.1. it exists—the demanded record is rᵢ. End of search;
      2.1.2. it does not exist—check the value of r:
         r=null—there is no record with key x in the tree. End of search;
         r!=null—the demanded record is r. End of search;
   2.2. N is an internal node—branch bᵢ is selected, for which the following two conditions are fulfilled:
      a) bᵢ.k≦x;
      b) if next branch bᵢ₊₁ does not exist in N, then x<bᵢ₊₁.k;
   The sequence S=oᵢ_{ₛ}, oᵢ_{ₛ₊₁}, . . . , oᵢ_{ₜ} consists of operations adjacent to bᵢ, for which oᵢ_{ᵥ}.k=x is fulfilled, where v=s, s+1, . . . , t, and depending on the number of operations in S there are:
      c>0—it is assigned to z←t:
      While z≧s, depending on operation oᵢ_{_{z}}.t one of the cases is executed:
         oᵢ_{_{z}}.t=Replace—the demanded record is (oᵢ_{_{z}}.k, oᵢ_{_{z}}.v). End of search;
      oᵢ_{_{z}}.t=Delete—check the value of r:
         r=null—there is no record with key x in the tree. End of search;
         r!=null—the demanded record is r. End of search;
      oᵢ_{_{z}}.t=Read—it is assigned to z←(z−1);
      oᵢ_{_{z}}.t=InsertOrIgnore—it is assigned to r←(oᵢ_{_{z}}.k, oᵢ_{_{z}}.v), it is assigned to z←(z−1).
      c=0—do nothing.
   It is assigned to N←bᵢ.p, and after that it sinks down the tree, following branch bᵢ. Go to step 2.

### Embodiment 2

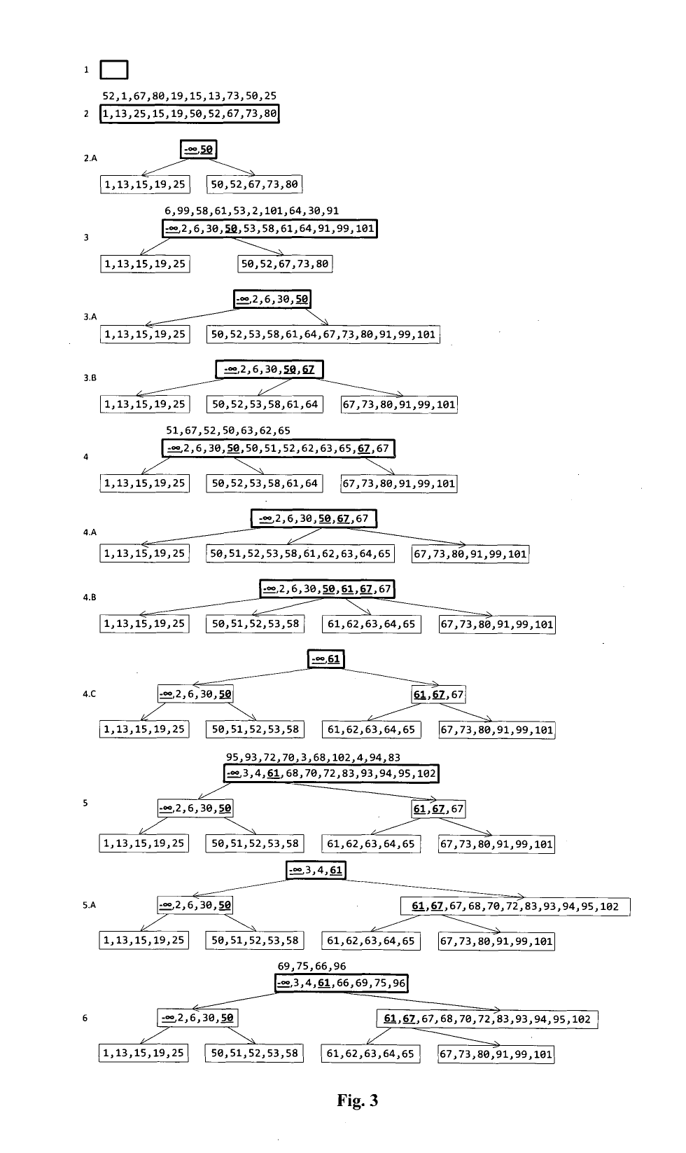

A method of data indexing has been developed (FIG. 3), and it has been implemented by inputting operations only of Replace type and concrete keys to the operations, observing the sequence from Embodiment 1, i.e.:

The operations are input into an empty tree, consisting only of root node of leaf type (FIG. 3, step 1) and operations are consecutively executed above the root node by ApplyLeaf( ) with keys 52, 1, 67, 80, 19, 15, 13, 73, 50, 25 (FIG. 3, step 2).

If the maximum number of records in a leaf is R̅=9, then the root node (of leaf type) overflows with records. Go to splitting it by SplitLeaf( ) (FIG. 3, step 2.A):

1. a new leaf is created and half of the records are transferred to it.

2. a new root node with two branches is created pointing to the old leaf and to the newly-created leaf. The height of the index tree increases by one level.

Operations with keys 6, 99, 58, 61, 53, 2, 101, 64, 30, 91 are applied in succession above the root node (of internal node type) by ApplyInternal( ) (FIG. 3, step 3). It is determined for each operation to which branch it belongs (conditions a and b of item 1 from Applylnternal( ) of Embodiment 1).

If the maximum number of operations in internal node is Ō=9, then the root node overflows with operations. Go to pouring down operations into lower nodes by Sink( ) (FIG. 3, step 3.A). To this end, the branch with the greatest number of adjacent operations is chosen (in this case with key 50), and its adjacent operations (with keys 53, 58, 61, 64, 91, 99, 101) pour down into the node pointed by the branch, i.e. in this concrete case these operations are removed from the root node and they are applied above the leaf pointed by branch 50 (FIG. 3, step 3.A). This leads to overflow with records of the right leaf (FIG. 3, step 3.A). Go to splitting the leaf (FIG. 3, step 3.B). In this case the leaf has a parent node and a new branch is created in its parent node. The branch points to the newly-created leaf.

Operations with keys 51, 67, 52, 50, 63, 62, 65 are applied in succession above the root node (FIG. 3, step 4), which results in overflow with operations of the root node and again branch 50 has the greatest number of adjacent operations which pour down the tree (FIG. 3, step 4.A), which leads to overflow with records of the leaf pointed by branch 50 and it splits (FIG. 3, step 4.B).

If the maximum number of branches in an internal node is B̅=3, then the root node overflows with branches. Split it by SplitInternal( ) (FIG. 3, step 4.C).

Similarly continue with operations 95, 93, 72, 70, 3, 68, 102, 4, 94, 83, 69, 75, 66, 96 (FIG. 3, step 5, 5.A, 6).

### Embodiment 3

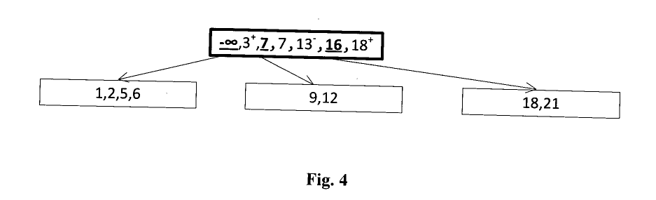

A method of data indexing has been developed (FIG. 4), comprising the actions described in Embodiment 1, Unlike Embodment 1, branches have records as well, to which operations are also applied.

### INDUSTRIAL APPLICABILITY

The implementation of the method according to the invention has been illustrated in the described embodiments but they do not limit it only to the shown types of operations, keys fields, matrices for applying operations and conditions for accumulating and pouring down operations.

The known B⁺-tree can be considered as a particular case of the index tree built according to the invention when the internal nodes of the tree do not have operations.

The usage of B⁺-tree or its variety can be replaced by a tree according to the method described in this invention by accumulating operations in the internal nodes and subsequent pouring down of operations from these nodes down the tree.

The method described in Embodiment 3 shows that it can be implemented also on B-tree or on its varieties.

### CITATION LIST

1. Organization and maintenance of large ordered indices—R. Bayer, E. McCreight;
2. The ubiquitous B-tree—Douglas Comer;
3. B tree Donghui Zhang, Northeastern University.

1. A method of data indexing by an index tree comprises the following:
1. One or more operations are input into the index tree which has a logical structure similar to B-tree B⁺-tree;
2. The new coming operations are executed by applying them to the root node of the index tree,
characterized by the fact that in addition to each branch of the internal nodes of the tree, adjacent operations are also recorded which after accumulating pour down in groups to the lower nodes until the total number of adjacent operations in the respective node is reduced below a preset limit and this is repeated for each node.

2. A method according to claim 1 wherein the new coming operations are applied to node N as follows:
A. If N is an internal node it is executed in succession:
A.1. For each newly come operation o branch b is found in N according to its key, in one of the known ways and then o is applied to operations adjacent to b and there are two possible cases:
if operations adjacent to be exist with keys identical to the key of o, then o is applied to these operations according to predefined rules and as a result the number of these adjacent operations can change and/or the fields of some of them can be modified;
if operations adjacent to b do not exist with keys identical to the key of o, then o is added to them.
A.2. It is checked if node N overflows with operations, i.e. if their total number exceeds a preset limit and there are two possible cases:
node N overflows—part of operations of N pour down the tree until their total number is reduced below a preset limit and to this end, every time branch b of N is selected for which there is the greatest number of accumulated adjacent operations and they sink down the tree following branch b, i.e. all operations adjacent to b are removed and then the removed operations are applied to the note pointed by b;
node N does not overflow—the performance of the input operations method ends.
B. If N is a leaf each newly come operation is applied to the records in N according to predefined rules, whereat records with unique keys always remain in the leaf and depending on the number of records in N one of the following actions is executed:
N overflows with records, i.e. the number of records in N is greater than a preset limit the leaf splits in one of the known ways and if necessary the splitting process spreads up the tree similarly to B⁺-tree, with the difference that the branches carry with them their adjacent operations as well and in case the newly formed leaves overflow with records, the splitting process is executed for them as well;
N underflows, i.e. the number of records in N is smaller than a preset limit the leaf merges with an adjacent leaf and if necessary the merging process spreads up the tree, similarly to B⁺-tree, with the difference that the branches carry also the adjacent operations with them, and in case the newly formed leaves underflow with records, the merging process is executed for them as well;
N neither overflows nor underflows—the performance of the input operations method ends.

3. A method according to claim 2 wherein the predefined rules are a set of possible combinations between the operations.

4. A method according to claim 3 wherein the set of possible combinations between the operations is a matrix of operations.

5. A method according to claim 1, characterized by the fact that when operations sink in the tree, they can replace one another, annihilate and/or produce new operations.

6. A method according to claim 2, characterized by the fact that when operations sink in the tree, they can replace one another, annihilate and/or produce new operations.

7. A method according to claim 3, characterized by the fact that when operations sink in the tree, they can replace one another, annihilate and/or produce new operations.

8. A method according to claim 4, characterized by the fact that when operations sink in the tree, they can replace one another, annihilate and/or produce new operations.
